(19) United States
(12) Patent Application Publication
(10) Pub. No.: US 2013/0007368 A1
(43) Pub. Date: Jan. 3, 2013

(54) METHODS AND SYSTEMS FOR IMPROVED MIORRORING OF DATA BETWEEN STORAGE CONTROLLERS USING BIDIRECTIONAL COMMUNICATIONS

(75) Inventors: Randolph W. Sterns, Arvada, CO (US); Randy K. Hall, Boulder, CO (US)

(73) Assignee: LSI CORPORATION, Milpitas, CA (US)

(21) Appl. No.: 13/172,413

(22) Filed: Jun. 29, 2011

(51) Int. Cl. G06F 12/08

(52) U.S. Cl. 711/124; 711/E12.023

(57) ABSTRACT

Methods and systems for improved transfer of mirrored information between paired dual-active storage controllers in a storage system using a SCSI transport layer. A first portion (approximately half) of the mirrored information transfers are performed in accordance with a first manner in which the controller to receive the mirrored information issues a read operation on the initiator-target nexus (ITN) of the SCSI transport layer to retrieve the mirrored information. A second portion (approximately half) of the mirrored information transfers are performed according to a second manner in which the controller having the information to be mirrored sends the information to be mirrored to the partner controller using a write operation on the ITN. The read and write operations on the same ITN may thus overlap to improve inter-controller communications. The mirrored information may be cached write data or entire I/O requests to be shipped to a partner controller.

### BACKGROUND

1. Field of the Invention

The invention relates generally to storage systems and more specifically relates to methods and systems for improved throughput in mirroring of cache data between two storage controllers by use of bidirectional transmission on a common initiator-target nexus (ITN).

2. Discussion of Related Art

Many high performance, high reliability storage systems utilize multiple storage controllers to increase both performance and reliability. Where multiple storage controllers are utilized, it is common that the controllers exchange information in the processing of host requests received from attached host systems. A variety of communication media and protocols may be used for such exchange of information between the multiple storage controllers of the system. Some common commercially available communication media and protocols for inter-controller communications include, Serial Attached SCSI (SAS), Fibre Channel (FC), Infiniband, PCI-Express, Ethernet, etc.

One common configuration of multiple inter-connected controllers is often referred to as “dual-active” or “active-active”. Each controller of the dual-active pair comprises a cache memory used to enhance performance of its I/O request processing. In the dual-active configuration, each controller is actively processing I/O requests from attached host systems and utilizes its local cache memory for enhancing performance. Further, each active controller serves as a redundant backup for the other active controller to improve reliability in case of a failure of the other controller. Though the controllers operate substantially independently processing I/O requests, the dual-active controllers need to share cache data so that when one controller takes over control of the I/O requests for the other (failed) controller the data in the cache memory of the other (failed) controller will be known/available to the remaining active controller.

In this dual-active configuration, each controller processes an I/O request (i.e., a write request) by writing data to its local cache (and eventually flushing the data from cache to the storage devices). The controller also mirrors or copies the data just written in its local cache memory to the local cache memory of the other active controller. Thus, each controller has full knowledge of the cache data in the other controller to allow “fail-over” by a remaining active controller in the event of failure of the other active controller. The copying of cache data from the local cache of one controller to the other controller is often referred to as “mirroring” of the cache data. The inter-controller communication media and protocols are used for this mirroring of cache data between the dual-active controllers.

There are several methods for mirroring cache data depending on the architecture of the storage system. In embodiments that use the SCSI transport protocol as a layer on top of the underlying, lower-level, inter-controller communication protocols (e.g., SAS), one current technique moves the mirrored cache data across the same SAS channels that distribute data to the drives. These mirror related transactions compete for bandwidth with the write data going to the drives. In the worst case the controller's effective host bandwidth is cut in half because the data must be mirrored to the other controller and must be written to disk.

When both controllers are mirroring write data the SAS connections begin to flow data in both directions, but this does not meet the requirements of Bi-directional data flow, since the mirroring traffic flows in only in one direction on the same initiator target nexus (I_T nexus or “ITN”). In present dual-active SAS architectures, both dual-active controllers may be simultaneously attempting to write data to the other controller's cache memory. These otherwise simultaneous write transaction cannot use the same ITN (i.e., write transactions cannot simultaneously flow in opposite directions on a single established ITN connection). Even though data is flowing in both directions on the same SAS PHY (the same physical link coupling the controllers), each of the controllers are issuing writes on different ITNs. This is because both controllers are initiating the mirrored data write operations and sending mirror data to the other controller. Such a typical mirror data flow as presently practiced allows no chance to take advantage of the bidirectional nature of SAS.

Thus it is an ongoing challenge to reduce overhead and bandwidth utilization in the exchange of mirrored cache data between pairs of dual-active storage controllers.

### SUMMARY

The present invention solves the above and other problems, thereby advancing the state of the useful arts, by providing methods and systems for improved transfer of mirrored information between paired dual-active storage controllers in a storage system using a SCSI transport layer. A first portion (approximately half) of the mirrored information transfers are performed in accordance with a first manner in which the controller to receive the mirrored information issues a read operation on the initiator-target nexus (ITN) of the SCSI transport layer to retrieve the mirrored information. A second portion (approximately half) of the mirrored information transfers are performed according to a second manner in which the controller having the information to be mirrored sends the information to be mirrored to the partner controller using a write operation on the ITN. The read and write operations on the same ITN may thus overlap to improve inter-controller communications. The mirrored information may be cached write data or entire I/O requests to be shipped to a partner controller.

In one aspect hereof, a method is provided operable in a first storage controller for mirroring cached write data with a second storage controller. The method comprises receiving a write I/O request from an attached host system wherein the write I/O request comprises write data. The method then stores the write data in a cache memory of the first storage controller wherein the write data is stored at a starting location in the cache memory. Responsive to receipt of the write I/O request, the method then transmits a first command to the second storage controller wherein the first command comprises indicia of the starting location in the cache memory of the write data. The method then receives a second command from the second storage controller wherein the second command comprises a request to read the write data from the starting location. Responsive to receipt of the second command, the method then transfers the write data from the starting location in the cache memory to the second storage controller.

Another aspect hereof provides a method and associated system in which the method is operable. The method is operable in a first storage controller for transferring information to a second storage controller wherein the first and second storage controllers are coupled by SCSI transport logic operable over a communication medium coupling the first and second storage controllers. The method comprises receiving a plurality of I/O requests from one or more attached host systems and storing information derived from each I/O request in a memory of the first storage controller wherein the information derived from each I/O request is stored at a corresponding starting location in the memory. For each I/O request of a first portion of the plurality of I/O requests, the method then transfers the information from the memory of the first storage controller to the second storage controller according to a first manner. For each I/O request of a second portion of the plurality of I/O requests, the method transfers the information from the memory of the first storage controller to the second storage controller according to a second manner. The first manner further comprises, responsive to receipt of each I/O request of the first portion, transmitting a first command to the second storage controller wherein the first command comprises the starting location in the memory of the information derived from said each request of the first portion. The first manner further comprises receiving using an initiator-target nexus (ITN) of the SCSI transport layer, a second command from the second storage controller wherein the second command comprises a request to read the information from the starting location in the memory. The first method still further comprises, responsive to receipt of the second command, transmitting, using the ITN, the information from the starting location in the memory specified by the second command to the second storage controller. The second manner further comprises, responsive to receipt of each I/O request of the second portion, transmitting, using the ITN, a third command to the second storage controller wherein the third command comprises the information derived from said each I/O request.

### BRIEF DESCRIPTION OF THE DRAWINGS

FIG. 1 is a block diagram of an exemplary system comprising a pair of dual-active storage controllers enhanced in accordance with features and aspects hereof to improve mirrored information transfers between the controllers.

FIGS. 2 through 6 are flowcharts describing exemplary methods in accordance with features and aspects hereof to improve mirrored information transfers between paired dual-active storage controllers.

### DETAILED DESCRIPTION OF THE DRAWINGS

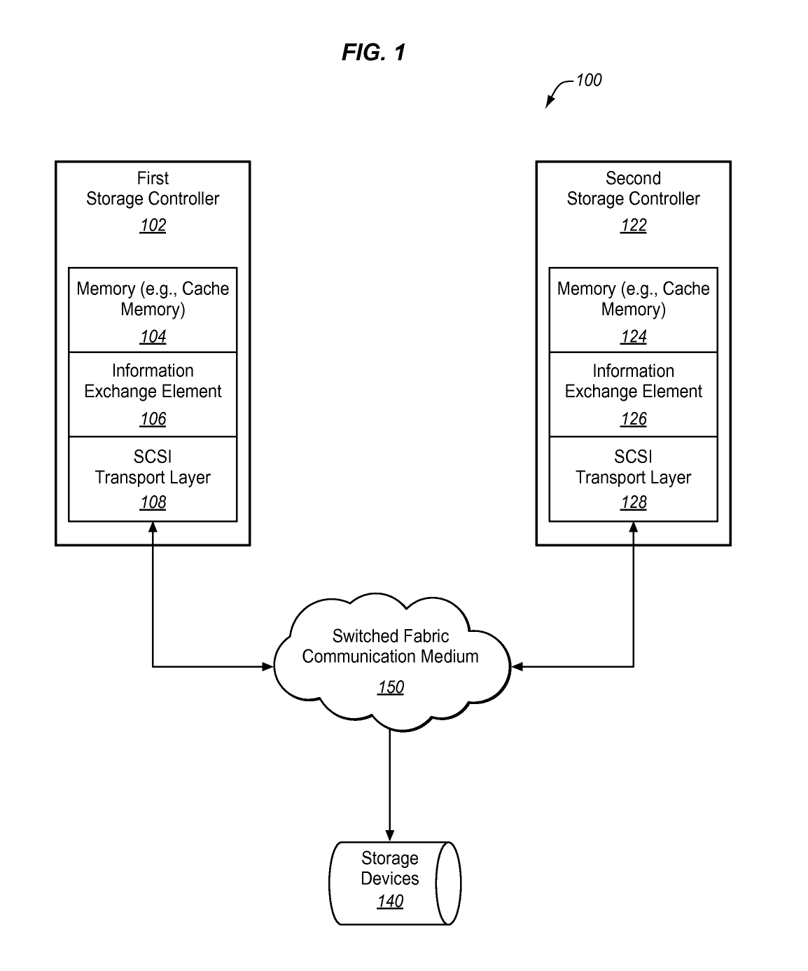

FIG. 1 is a block diagram of a system 100 enhanced in accordance with features and aspects hereof to improve inter-controller exchange of mirrored information. System 100 comprises first storage controller 102 and second storage controller 122 coupled through switched fabric communication medium 150 with each other and with storage devices 140. In one exemplary embodiment, first storage controller 102 and second storage controller 122 together comprise a “dual-active” or “active-active” pair of redundant controllers. In such a dual-active configuration, each storage controller may process I/O requests received from attached host systems substantially independent of the other storage controller of the dual-active pair. As is well known to those of ordinary skill in the art, storage controllers 102 and 122 each comprise a memory 104 and 124, respectively, used for storing or caching information relating to processing of I/O requests. In one exemplary embodiment, write I/O operations are processed, in part, by storing the write data associated with a write I/O request in the cache memory and, at some subsequent time, flushing or persistently storing the cached write data on storage devices 140. In a dual-active configuration, in addition to storing information in its own memory, each controller 102 and 112 must also mirror or copy any such stored information in the memory of the other controller. This permits each controller to serve in the role of a redundant controller to take over control of I/O processing in the event of a failure of its paired dual-active controller. In other embodiments, an entire I/O request, initially received and stored in a memory of a first controller of the dual-active pair, may be transmitted to the other controller for processing of the request. Such processing is often referred to as “I/O shipping”. Thus, the system of FIG. 1 may be used to enhance performance of dual-active storage controllers for mirroring of cache data, for I/O shipping between the controllers, as well as for other inter-controller communication functions. Though the discussion that follows focuses primarily on use of the systems and methods for cache mirroring between controllers, it will be understood that any inter-controller communications may benefit from the enhancements herein.

Minoring of stored information regarding processing of I/O requests is generally performed by inter-controller communication. Switched fabric communication medium 150 may be used for such inter-controller communication between first storage controller 102 and second storage controller 122. In addition, switched fabric communication medium 150 may be used to couple both controllers 102 and 122 to storage devices 140. Features and aspects hereof to improve performance of the inter-controller communications may be beneficially applied regardless of whether the inter-controller communication medium is shared with the controller-storage device communication channel or is distinct from the storage device communications.

Each controller 102 and 122 comprises a corresponding SCSI transport layer 108 and 128, respectively. The SCSI transport layer (and associated lower link and physical layers) permit the controllers 102 and 122 to communicate with storage devices 140 as well as with the other controller of the dual-active pair. An initiator-target nexus (ITN) identifies a particular connection between a particular pair of devices in the SCSI environment. As presently practiced in the art, each controller 102 and 122 may perform required mirroring of information in its memory (104 and 124 respectively) by performing SCSI write operations using the ITN associating with the initiator controller and with the target controller for the mirrored information write operation. As noted above and in accordance with SCSI standards, where both controllers are processing requests at a substantially equal rate, the ITN associating the two storage controllers may not be used simultaneously for two write operations—e.g., a write operation from the first storage controller to mirror its information to the second storage controller and another write operation using the same ITN for the second storage controller to mirror its information to the first storage controller.

By contrast, storage controllers 102 and 122 are enhanced in accordance with features and aspects hereof to provide for bidirectional communication utilizing the same ITN for purposes of mirroring information between the two storage controllers of the dual-active pair. In particular, features and aspects hereof utilize combinations of read requests and write request on the same ITN to permit substantial overlap (i.e., bidirectional simultaneous communication) of mirroring operations between the two controllers. An information exchange element 106 and 126 in each storage controller 102 and 122, respectively, serves to coordinate the use of such bidirectional communications utilizing a single ITN between first storage controller 102 and second storage controller 122 for purposes of mirroring information in their respective memories 104 and 124. The information exchange elements as well as the SCSI transport layers may be implemented as suitably programmed instructions stored in a memory (not shown) of the controllers and executed by an appropriate general or special purpose processor (not shown). Further, these elements may also be implemented as suitably designed logic circuits or combinations of logic circuits and suitable programmed instructions.

In operation, each controller 102 and 122 is adapted/operable to receive a plurality of I/O requests from attached host systems. For any given I/O request, the controller receiving the request may be designated as the “managing” controller and the other controller may be designated as the “partner” controller for purposes of processing that request. The managing controller is operable to store information regarding its received request and further operable to mirror the stored information to the partner controller (i.e., to be stored in the partner controller's memory). Further, the managing controller is operable to perform this mirroring operation in accordance with a first manner for a first portion of the plurality of received I/O requests and in accordance with a second manner for the remaining or second portion of the plurality of received I/O requests. In accordance with the first manner of performing the mirroring operation, the managing controller transmits a first command to its partner controller indicating to the partner controller that information is available in the memory of the managing controller. The first command identifies the information but does not transmit the data as a write operation to the partner controller. The information may be identified by its starting address and length in the memory of the managing controller and/or may be identified by a tag value created by the managing controller. The managing controller then later receives from its partner controller a second command identifying the information to be read from memory of the managing controller. The information is identified in the second command by the starting location and/or tag value sent from the managing controller in the first command. This second command comprises a read operation requesting return of the identified information. Responsive to receiving the second command the managing controller transmits the requested information from the starting location in its memory to the second/partner controller thereby satisfying the read request of the partner controller. In this first manner of performing the mirror operation, the data information to be mirrored is transmitted over a SCSI transport layer using a single ITN utilizing a read request from the partner controller to the managing controller.

In accordance with the second manner of performing the mirroring operation, the managing controller transmits the information relating to the I/O request to the partner controller utilizing a write operation on the SCSI transport layer using the same ITN used by the first manner for performing a read operation. By performing both read and write operations on the same ITN, and by performing the same operation in each controller (each operating as the managing controller for its received I/O requests), the data flows for the read and write operations on the same ITN may be substantially overlapped thus improving bandwidth utilization of the inter-controller communications and reducing latency in the communications as compared to prior techniques that utilize only write operations between the paired dual-active controllers for purposes of mirroring information.

In one exemplary embodiment each managing controller may alternate use of the first and second manners of mirroring information. The alternation may be performed by switching manners for each mirror operation to be performed by the managing controller or the manners of mirroring may be switched after a predetermined number of mirror operations have been performed using one or the other manner of mirroring. In other exemplary embodiment, one of the two controllers may be configured to always utilize the first manner of mirroring operation while the other controller may be configured to always utilize the second manner for mirroring operations. In such an alternate embodiment, read and write operations may still be overlapped by utilizing the same ITN for the mirror operations performed by the first controller using write operations and the mirror operations perform a second controller using read operation. In some embodiments it may be preferred that the two controllers are operating using identical control code and logic. Hence, it may be preferred that the two controllers operate in an identical manner alternating use of the first and second manners of mirroring operation so that the code/logic may be identical between the paired dual-active controllers.

The switched fabric communication medium 150 may be utilized for coupling first and second storage controllers 102 and 122 as well as for coupling each controller with storage devices 140. Fabric 150 may be any of several well-known, commercially available communication media and associated protocols that provide for SCSI transport layers to be utilized within each controller. For example, switched fabric communication medium 150 may provide for Serial Attached SCSI (SAS) communications or may provide Fibre Channel (FC) communications. Other well-known switched fabric communication media and protocols may be utilized that also allow for a SCSI transport layer to be utilized in communications between storage controllers. Thus, in some exemplary embodiments, first storage controller 102 and second storage controller 122 made each comprise SAS storage controllers or may each comprise Fibre Channel storage controllers. In like manner, storage devices 140 may be SAS storage devices or FC storage devices. Still further, features and aspects hereof also permit overlap of the mirror operations to transfer information between storage controllers 102 and 122 with the transfers of information (e.g., write data) to the storage devices 140 from a managing controller of an I/O request.

Those of ordinary skill in the art will readily recognize numerous additional and equivalent elements that may be present in fully functional storage controllers 102 and 122. Such additional and equivalent elements are omitted herein for simplicity and brevity of this discussion. For example, those of ordinary skill in the art will readily recognize that storage controllers 102 and 122 may include one or more general or special-purpose processors and associated memory for storing programmed instructions for performing mirroring and other operations by the controllers. In addition or in the alternative, storage controllers 102 and 122 may comprise suitably designed logic circuits for processing of incoming I/O requests and for performing the mirroring operations described herein. Still further, those of ordinary skill in the art will readily recognize that the information to be mirrored by the mirror operations described herein may comprise write data cached in the memory 104 or 124 of the managing controllers 102 and 122, respectively, stored by the managing controller's processing of received write I/O requests. In a dual-active storage controller configuration, write data is stored in a cache memory of the storage controller and mirrored to the cache memory of the other controller of the dual-active configuration. Still further, in other exemplary embodiments, the information to be mirrored may comprise the entire I/O request per se. In other words, an I/O request may be stored in the memory of the managing controller and the request may be “shipped” in its entirety to the partner controller for processing of the entire request. Thus the mirror operations described herein may be used for cache memory mirroring in dual-active storage controller configurations or for I/O shipping in such dual-active configuration as well as for other purposes readily recognized by those of ordinary skill in the art.

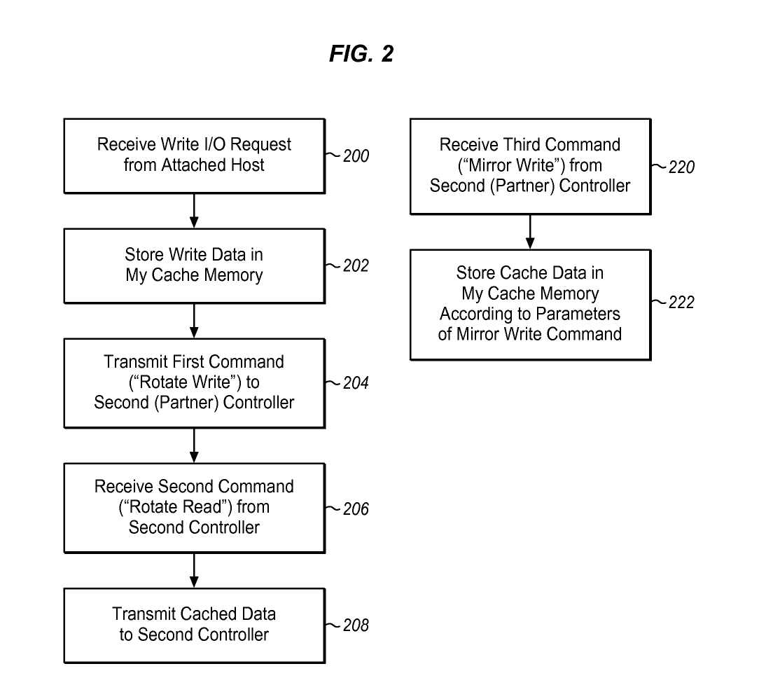

FIG. 2 is a flowchart describing an exemplary method for improved mirror operations in accordance with features and aspects hereof. The method of FIG. 2 provides improved mirroring operations from the perspective of one controller of a pair of dual-active controllers. More specifically, in FIG. 2, the first controller is involved in mirroring operations between the first and second storage controllers both processing write I/O requests from attached systems. Thus, the methods of FIG. 2 may be operable in a first storage controller 102 as described above in FIG. 1. Steps 200 through 208 express the method operable in the first controller to transfer mirrored cache data to the second controller in accordance with the first manner as described above while steps 220 through 222 express a method operable in the first controller to receive mirrored cache data from the second storage controller in accordance with a second manner as expressed above. At step 200, the first storage controller receives a write I/O request from an attached host. Responsive to receipt of the write I/O request, step 202 stores the write data associated with the received request into its cache memory (i.e., as cached write data). At step 204, the first storage controller transmits a first command to the second controller. The first command may also be referred to herein as a “Rotate Write” command (RW). This first command does not provide any of the cached write data but rather provides identification information indicating to the second or partner controller where information to be mirrored may be located. In some exemplary embodiments, the first command may include a tag or unique ID associated with the received write I/O request to aid in locating the cached write data to be transferred to the second controller. In other embodiments, an address in the first controller's cache memory or other locating information may be transferred to the second controller. At step 206, the first controller receives from the second controller a second command also referred to herein as a “Rotate Read” command (RR). The second command is a read operation issued by the second controller and provides the location and/or tag information used by the first controller to locate the cached write data to be transferred to the second controller. At step 208, the first controller transmits the located cached write data to the second controller. In the method of steps 200 through 208, the received second command (RR) and the transmitted cached write data are exchanged using a single ITN of the SCSI transport layer in each of the dual-active controllers.

Both controllers are also capable of utilizing a standard technique for mirroring cached write data between the controllers. Steps 220 through 222 described steps in the first controller for receiving a standard cache mirror operation from the second controller. At step 220, the first controller receives a third command from the second controller. The third command is also referred to herein as a “Mirror Write” command (MW) and represents typical processing as presently practiced in the art for mirroring cached write data utilizing a write request between the paired controllers. At step 222, first controller stores the cached data received with the MW command in accordance with parameters identified in the MW command (e.g., at locations in cache memory identified by the parameters of the MW command). This MW command utilizes the same ITN of the SCSI transport layers as is utilized by the RR command as above with respect to steps 206 and 208.

As noted above, by utilizing both read and write operations for mirroring cached write data over the same ITN, substantial overlap may be achieved such that the essentially simultaneous bidirectional transfer of mirrored cache data between the storage controllers improves inter-controller communication bandwidth utilization and reduces overhead latency in such mirrored data transfers. Still further, those of ordinary skill in the art will recognize that the first command (the RW command) may be transferred from the first controller to the second controller using the same ITN as is used for the second and third commands as well as for the data transferred responsive to receipt of the second command. In some embodiments, the first command may be transferred using a different ITN to further avoid congestion and latency associated with use of the same ITN for write operations in both directions of the single ITN.

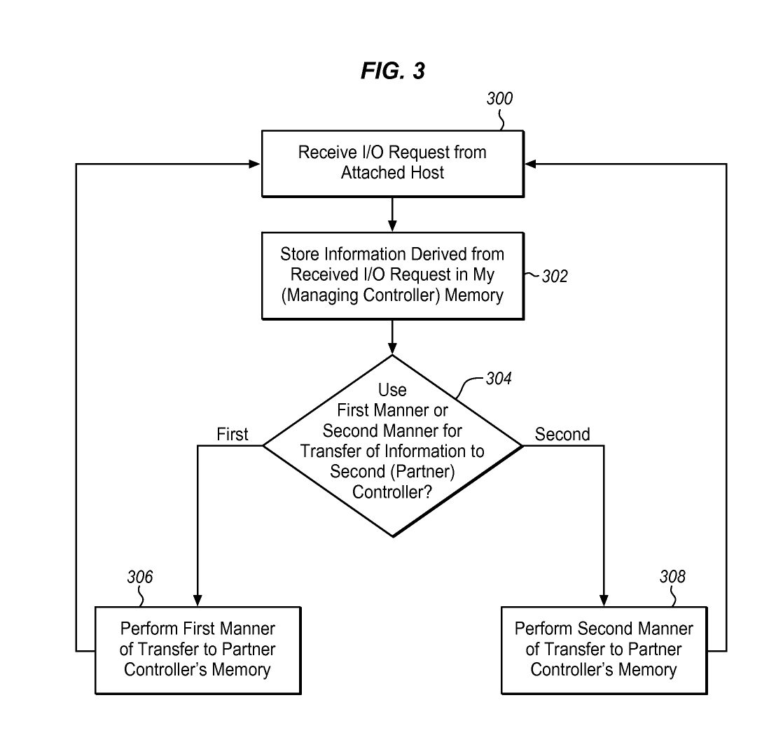

FIG. 3 is a flowchart describing another exemplary method for improving mirror operations between the pair of dual-active storage controllers. The method of FIG. 3 may be performed essentially identically by each of a pair of dual-active controllers each comprising a SCSI transport layer such as the dual-active controllers 102 and 122 of FIG. 1. The method of FIG. 3 describes identical operations to be performed by each of the paired controllers responsive to receiving I/O requests from attached host systems. More specifically, the method of FIG. 3 describes processing for each received I/O request by the managing controller (i.e., the controller that received the I/O request to be processed). At step 300 the managing controller receives an I/O request from an attached host system. The I/O request may be either a read or write request for accessing data from attached storage devices. At step 302, the managing controller stores in its memory information derived from the received I/O request. In some embodiments, the information derived from the received I/O request may be write data of a write I/O request stored in the cache memory of the managing controller. In other embodiments, the information derived from the write request may be essentially the I/O request per se. In either embodiment, the information so derived and stored is to be mirrored or copied in some manner to the partner controller of the dual-active pair. At step 304, the managing controller determines whether the information is to be mirrored in accordance with a first manner or a second manner of transferring information from the managing controller's memory to the partner controller. If step 304 determines that the information is to be transferred using a first manner, step 306 performs the desired transfer from memory of the managing controller to the partner controller in accordance with a first manner of transferring data (as further described below). Otherwise, step 308 performs the desired mirroring transfer from the memory of the managing controller to the second controller in accordance with a second manner (as described further below). In either case, processing for mirroring of the information is completed, the I/O request is processed accordingly by the managing controller and processing continues looping back to step 300 to await receipt of a next I/O request from an attached host.

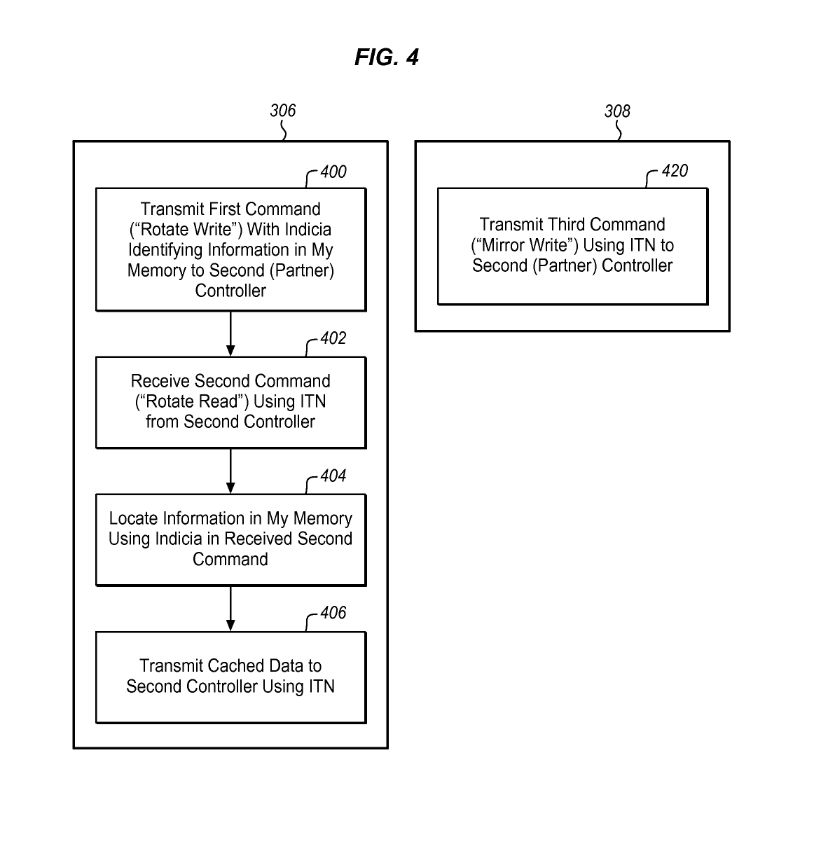

FIG. 4 is a flowchart providing exemplary additional details of the first manner of transferring mirrored information and the second manner of transferring mirrored information. Step 400 through 406 provide exemplary additional details of step 306 of FIG. 3 for performing the mirrored operation in accordance with first manner while step 420 provides exemplary additional details for performing the mirror operation in accordance with a second manner as in step 308 of FIG. 3. In accordance with the first manner of mirror operation, step 400 transmits a first command (an RW command) from the managing controller to the partner controller. The RW command comprises tag or other indicia identifying the information in the managing controller's memory to be transferred. The actual data to be transferred is not included with the first command but rather information identifying the information to be mirrored is transferred by the first command. As noted above, the RW command may be transferred to the partner controller using any suitable ITN of the SCSI transport layers of the controllers. At step 402, the managing controller receives a second command (an RR command) from the partner controller. The RR command comprises the tag or other indicia provided originally by the first command. At step 404, the managing controller locates the identified information in its memory using the tag or other indicia provided in the received second command (e.g., provided in the RR command). The RR command (second command) is received on a specific ITN provided by the SCSI transport layers of both controllers. Responsive to receipt of the second command, step 406 then transmits the cached data information from the managing controller to the partner controller using the same ITN utilized by the second command. Step 420 describes the processing of the second manner for exchanging mirrored information between the controllers. Specifically, step 420 represents the transmission of a third command (e.g., an MW command) using the same ITN has used for the RR command (second command) previously received by the managing controller. The MW command comprises the information to be transferred from the memory of the first controller managing controller to the partner controller. As will be understood by those of ordinary skill in the art, the first manner represented by step 400 through 406 and the second manner represented by step 420 utilize the same ITN of the SCSI transport layers for transferring information from the memory of the managing controller to the partner controller. However, in the first manner the information is transferred by causing the partner controller to issue a read request on the ITN while in the second manner information is transferred by the managing controller issuing a write on the same ITN. Thus, the bidirectional capabilities of a single ITN in the SCSI transport layer may be utilized to provide for overlapping transfers of information from the memory of the managing controller to the memory of the partner controller.

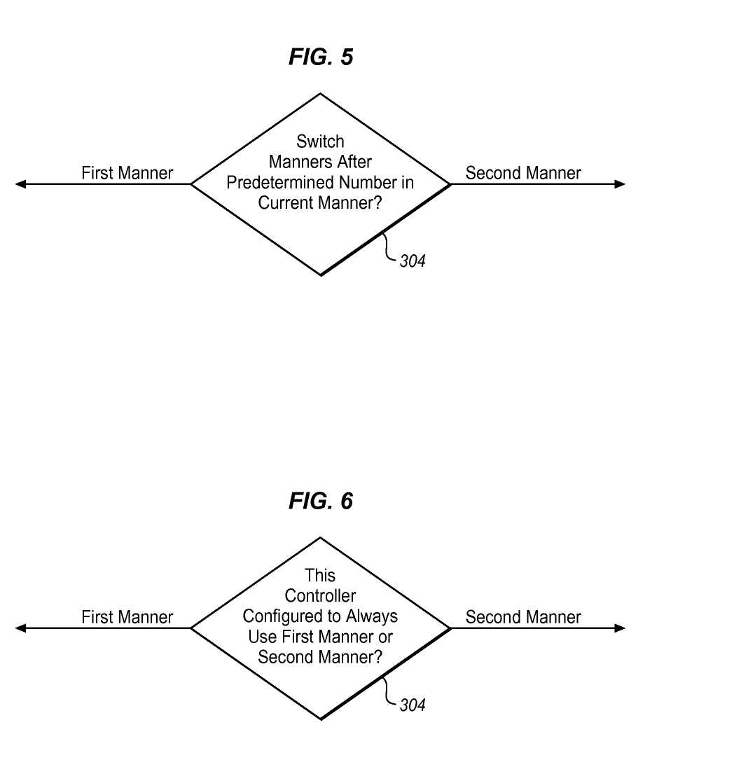

FIGS. 5 and 6 provide exemplary additional details of the processing of step 304 of FIG. 3 to determine whether the first or second manner of transferring information from the managing controller memory to the partner controller should be used. In FIG. 5 step 304 selects between the first and second manner within the managing controller based on a predetermined number of usages of the first or second manner of transfer. For example, the managing controller may provide for strict alternation between the first manner and the second manner for every other received I/O request. In other embodiments, a predetermined number of transfers may be performed utilizing the first manner followed by a predetermined number of transfers utilizing the second manner. In general, step 304 of FIG. 5 provides that approximately half of the received I/O operations (a first portion) will utilize the first manner of transferring mirrored information while the remaining half (a second or remaining portion) will utilize the second manner for transferring information to the partner controller. Thus, if both of the paired controllers utilize the same method (i.e., methods of FIGS. 2-6), substantial overlap may be achieved by utilizing both read and write operations on the same ITN to utilize the bidirectional capability of a SCSI transport layer.

In FIG. 6, step 304 determines which manner to utilize in the managing controller based upon a predefined configuration of the managing controller to always use the first or always use the second manner of transfer. For example, the first controller (e.g., 102 of FIG. 1) may always use the first manner of transferring mirrored information when it performs in the role of a managing controller while the second controller (e.g., 122 of FIG. 1) may always use the second manner for transferring mirrored information to the first controller 102 of FIG. 1. Again, if the controllers are processing requests at an approximately equal pace or volume, the read operations of the first manner allow for substantial overlap with the write operations of the second manner while both approaches use the same ITN of the SCSI transport layers.

Regardless of the manner of selecting between the first and second manner of transfer of mirrored information, the first and second controllers utilize the mixture of the first and second manners of transfer such that substantial overlap may be achieved in the transfer of information between the dual-active storage controllers utilizing a single ITN of the SCSI transport layers.

Those of ordinary skill in the art will readily recognize numerous equivalents and additional steps that may be present in fully operational methods such as the method of FIGS. 2 through 5. Such additional and equivalent steps are omitted herein for simplicity and brevity of this discussion.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in a first storage controller for mirroring cached write data with a second storage controller, the method comprising:
receiving a write I/O request from an attached host system wherein the write I/O request comprises write data;
storing the write data in a cache memory of the first storage controller wherein the write data is stored at a starting location in the cache memory;
responsive to receipt of the write I/O request, transmitting a first command to the second storage controller wherein the first command comprises indicia of the starting location in the cache memory of the write data;
receiving a second command from the second storage controller wherein the second command comprises a request to read the write data from the starting location; and
responsive to receipt of the second command, transmitting the write data from the starting location in the cache memory to the second storage controller.

2. The method of claim 1 further comprising:
receiving a third command from the second storage controller wherein the third command cache data to be written to the cache memory of the first storage controller; and
responsive to receipt of the third command, storing the cache data in the cache memory of the first storage controller,
wherein the receipt of the cache data from the second storage controller substantially overlaps transmission of the write data to the second storage controller.

3. The method of claim 2
wherein the first command is transmitted using a SCSI initiator-target nexus (ITN) associated with a SCSI transport layer of the first and second storage controllers,
wherein the third command is received using the ITN, and
wherein the write data is transmitted using the ITN.

4. The method of claim 1
wherein the first storage controller and the second storage controller each comprise a SCSI transport layer for exchange of the first and second commands and for transmission of the write data.

5. The method of claim 4
wherein the first second storage controllers are both Serial Attached SCSI (SAS) storage controllers and wherein the first and second storage controllers are coupled by a SAS communication medium.

6. The method of claim 4
wherein the first and second storage controllers are coupled by a communication medium comprising one of: Serial Attached SCSI (SAS), Fibre Channel (FC), Infiniband, PCI-Express, or Ethernet.

7. The method of claim 4
wherein the first command is transmitted using an initiator-target nexus (ITN) associated with the SCSI transport layers of the first and second storage controllers,
wherein the second command is received using the ITN, and
wherein the write data is transmitted using the ITN.

8. A method operable in a first storage controller for transferring information to a second storage controller wherein the first and second storage controllers are coupled by SCSI transport logic operable over a communication medium coupling the first and second storage controllers, the method comprising:
receiving a plurality of I/O requests from one or more attached host systems;
storing information derived from each I/O request in a memory of the first storage controller wherein the information derived from each I/O request is stored at a corresponding starting location in the memory;
for each I/O request of a first portion of the plurality of I/O requests, transferring the information from the memory of the first storage controller to the second storage controller according to a first manner; and
for each I/O request of a second portion of the plurality of I/O requests, transferring the information from the memory of the first storage controller to the second storage controller according to a second manner,
wherein the first manner further comprises, responsive to receipt of each I/O request of the first portion, performing the steps of:
transmitting a first command to the second storage controller wherein the first command comprises the starting location in the memory of the information derived from said each request of the first portion;
receiving using an initiator-target nexus (ITN) of the SCSI transport layer, a second command from the second storage controller wherein the second command comprises a request to read the information from the starting location in the memory; and
responsive to receipt of the second command, transmitting, using the ITN, the information from the starting location in the memory specified by the second command to the second storage controller, and
wherein the second manner further comprises, responsive to receipt of each I/O request of the second portion, transmitting, using the ITN, a third command to the second storage controller wherein the third command comprises the information derived from said each I/O request.

9. The method of claim 8
wherein the first and second storage controllers are both Serial Attached SCSI (SAS) storage controllers and wherein the first and second storage controllers are coupled by a SAS communication medium.

10. The method of claim 8
wherein the first and second storage controllers are coupled by a communication medium comprising one of: Serial Attached SCSI (SAS), Fibre Channel (FC), Infiniband, PCI-Express, or Ethernet.

11. The method of claim 8
wherein the first portion comprises approximately half of the plurality of I/O requests, and
wherein the second portion comprises the remainder of the plurality of I/O requests.

12. The method of claim 8
wherein the indicia in the first command further comprises a unique tag associated with the information stored at the starting location specified in the first command,
wherein the second command further comprises the unique tag, and
wherein the first manner further comprises:
locating in the memory the information associated with the received unique tag.

13. The method of claim 8 further comprising:
substantially alternating between use of the first manner and use of the second manner for transferring information from the memory of the first storage controller to the second storage controller.

14. The method of claim 8
wherein the I/O requests are write I/O requests each comprising write data,
wherein the write data is stored in a cache memory of the first storage controller as cached write data, and
wherein the information stored in the memory comprises the cached write data for each write I/O request such that the first and second storage controllers maintain mirrored copies of the cached write data.

15. The method of claim 8
wherein the information comprises the entire I/O request and any data associated with the I/O request, and
wherein the I/O request is shipped to the second storage controller by the transfer of the information such that the second storage controller processes the I/O request.

16. A storage system comprising:
a first storage controller having a SCSI transport layer;
a second storage controller having a SCSI transport layer; and
a switched fabric communication medium coupling the SCSI transport layer of the first storage controller with the SCSI transport layer of the second storage controller,
wherein the first and second storage controllers are each operable to receive a plurality of I/O requests from attached host systems,
wherein, responsive to receipt of each I/O request, the storage controller receiving the I/O request is designated as a managing controller and the other storage controller is designated as a partner controller,
wherein the managing controller is further adapted to perform the following steps in response to receipt of each I/O request:
storing information derived from each I/O request in a memory of the managing controller wherein the information derived from each I/O request is stored at a corresponding starting location in the memory;
for each I/O request of a first portion of the plurality of I/O requests, transferring the information from the memory of the managing controller to the partner controller according to a first manner; and
for each I/O request of a second portion of the plurality of I/O requests, transferring the information from the memory of the managing controller to the partner controller according to a second manner,
wherein the first manner further comprises, responsive to receipt of each I/O request of the first portion, performing the steps of:
transmitting a first command to the partner controller wherein the first command comprises indicia of the starting location in the memory of the information derived from said each request of the first portion;
receiving, using an initiator-target nexus (ITN) of the SCSI transport layer, a second command from the partner controller wherein the second command comprises a request to read the information from the starting location in the memory; and
responsive to receipt of the second command, transmitting, using the ITN, the information from the starting location in the memory specified by the second command to the partner controller, and
wherein the second manner further comprises responsive to receipt of each I/O request of the second portion transmitting, using the ITN, a third command to the partner controller wherein the third command comprises the information derived from said each I/O request.

17. The system of claim 16
wherein the first and second storage controllers are both Serial Attached SCSI (SAS) storage controllers and wherein the switched fabric communication medium is a SAS communication medium.

18. The system of claim 16
wherein the first and second storage controllers are coupled by a communication medium comprising one of: Serial Attached SCSI (SAS), Fibre Channel (FC), Infiniband, PCI-Express, or Ethernet.

19. The system of claim 16
wherein the indicia in the first command further comprises a unique tag associated with the information stored at the starting location specified in the first command,
wherein the second command further comprises the unique tag, and
wherein the first manner further comprises:
locating in the memory the information associated with the received unique tag.

20. The system of claim 16
wherein the I/O requests are write I/O requests each comprising write data,
wherein the write data is stored in a cache memory of the managing controller as cached write data, and
wherein the information stored in the memory comprises the cached write data for each write I/O request such that the managing and partner controllers maintain mirrored copies of the cached write data.
